(19) United States
(12) Patent Application Publication
(10) Pub. No.: US 2015/0273258 A1
(43) Pub. Date: Oct. 1, 2015

(54) Fire Extinguishing System Comprising a Pipe and a Device for Injecting an Extinguishant

(71) Applicant: GE ENERGY PRODUCTS FRANCE SNC, BELFORT (FR)

(72) Inventor: CHRISTOPHE BOLLE, CHALONVILLARS (FR)

(21) Appl. No.: 14/639,147

(22) Filed: Mar. 5, 2015

(30) Foreign Application Priority Data
Mar. 28, 2014 (FR) 1452724

(51) Int. Cl. A62C 35/62; A62C 3/00

(52) U.S. Cl. CPC A62C 35/62; A62C 3/00

(57) ABSTRACT

The invention concerns a system to extinguish a fire in a machine cavity. The system may include a pipe and an injection device for injecting an extinguishant into the pipe. The pipe may include a first end connected to the injection device and a second end configured to be inserted in the machine cavity.

### TECHNICAL FIELD

The invention concerns the general domain of fire extinguishing systems. More specifically, the invention concerns fixed systems to protect a machine from fire, particularly a rotary machine in an industrial installation. To be even more precise, the invention concerns a fire-fighting system in a machine cavity, particularly a rotary machine cavity. The system may include a pipe, meant to be connected to the machine cavity, and a device for injecting an extinguishant in the pipe.

### BACKGROUND OF THE INVENTION

Known prior art fixed installations fight against fire. Known installations may include a network of pipes transporting an extinguishing liquid such as water. This network may be mounted off the ground, usually near the ceiling and may include, from place to place, nozzles with extinguishing liquid sprinklers sealed with thermally frangible bulbs. These nozzles with the sprinkler systems and the bulbs may protrude out from under their respective pipes and may be positioned above the areas to be protected. Under the effect of a strong temperature rise, the liquid contained in each bulb may expand and consequently may break the bulb. The nozzle orifice then opens up and the sprinkler system in the area of the fire is activated.

A fire may spark off in a restricted area inside a machine or close to a machine. This restricted area may be located under the machine or under a bearings cavity. Specifically, the bearings cavity may be located along the axis of the machine. A hot gas exhaust section, marked by the outer body of the machine and the outer wall of the cavity, may be located radially in relation to the cavity. A passage may be provided between the outer body of the machine and the cavity across the exhaust section. This passage may be provided for inspection and/or maintenance of the machine and also may serve as a ventilation duct. In fact, inside this cavity, a fire may be sparked off due to oil leakage combined with the presence of air and at high temperatures due to the friction of the bearings.

In each of the cases stated above, the time required to extinguish a fire should be as short as possible. In fact, if a considerably long time is taken to extinguish a fire, the industrial installation may suffer severe damage. The fastest possible intervention in the fire-affected area thus may be crucial. This also allows for reducing the time required to extinguish the fire.

Another problem is the quantity of the extinguishing liquid used in case of fire. In fact, heavy consumption of the extinguishing liquid also may cause considerable damage to the industrial installation and the like.

Furthermore, conventional methods such as mentioned above may not allow for local, and therefore quick intervention, in a cavity of an industrial installation and, specifically, in a cavity of a rotary machine such as a bearings cavity. Additionally, these methods may require heavy consumption of extinguishing liquid as all of the nozzles above the concerned area may have been activated.

### SUMMARY OF THE INVENTION

This invention thus provides a solution that allows for resolving all of the above-stated problems. Thus, this invention aims at creating a system that can extinguish a fire in a machine cavity. The system may have a pipe and an extinguishant injection device. One end of this pipe may be connected to the injection device and a second end may be configured to be inserted in the cavity. The cavity means a restricted area in a machine, or close to a machine, such as one bearing fuel, combustion, or sparks. More precisely, this cavity may be a restricted area under the machine or a bearings cavity.

According to the invention, the system allows for intervening directly in the machine cavity in case of fire. Furthermore, thanks to this system, only an appropriate quantity of extinguishant may be used. One also should understand that according to the invention, the system may allow extinguishing a fire while the machine is still operational. Favorably, according to the invention, the system is meant to be inserted in a rotary machine cavity such as a bearings cavity. The term “extinguishant” shall mean a composition including an active fire extinguisher. Furthermore, the extinguishant may be an aerosol product. According to a special execution technique, the extinguishant may be potassium-based. Specifically, a Stat-X® 2500E cartridge marketed by Aero-X AG is an example of an extinguishant injection device.

According to another feature of the invention, the pipe may include a first segment with one end connected to the extinguishant injection device and a second segment with one end meant to be inserted in the machine cavity. The first and the second segments may be connected to each other and the first segment may be above the second segment. Favorably, the connection between the ends of the two segments may be between about 1.5 and 2.5.

According to a preferred execution method, the size of the first section may be between about 170 and 230 mm. According to another preferred execution method, the size of the second segment may be between about 70 and 130 mm. These sizes may be governed by the size of the machine and the cavity and may vary. Specifically, the size of the first segment may depend on the diameter of the injection device whereas the size of the second segment may be based on the size of a manhole or a ventilation duct when such passage is provided. Preferably, the first segment and the second segment may be connected to each other with a cone coupling and the like.

According to a preferred manufacturing technique, the first segment may be divided into five parts. A first part, meant to be connected to the injection device, may define an outer angle with a second part. The second part and the third part may define a new outer angle. The plane defined by the first and the second parts may be orthogonal to the plane defined by the second and the third parts. The third part and a fourth part may define an outer angle in such a manner that the plane defined by the third and the fourth parts may be orthogonal to the plane defined by the second and the third parts and to the plane defined by the first and the second parts. The fourth part and a fifth part may define an obtuse outer angle in such a manner that the plane defined by the fourth and the fifth parts may be parallel to the plane defined by the first and the second parts. This configuration thus makes it possible to access easily the cartridge for any operation such as for mounting and changing of cartridge.

According to this same preferred manufacturing method, the second segment may be divided into two parts. A first part may be connected to the fifth part of the first segment with a cone coupling such that the first part of the second segment and the fifth part of the first segment may form an approximately 180° angle. Finally, the first part and a second part may define an obtuse outer angle in such a manner that the plane defined by the first and the second parts of the second segment may be noticeably parallel to the plane defined by the second and the third parts of the first segment. This configuration thus makes it possible to inject directly the extinguishant in the desired and specific area in the cavity.

In another manufacturing method, the pipe is meant to be inserted in the cavity through a manhole or ventilation duct. Favorably, the second segment may be configured in such a manner that the cone coupling remains outside the manhole or ventilation duct of the machine once the pipe is inserted in the machine.

In a favorable manufacturing method, the position and orientation of the end of the second segment in the cavity may be adjusted. Preferably, the quantity of the extinguishant injected in case of fire may be between about 1 and 5 kg, and by preference, between about 1 and 3 kg.

According to another feature of the invention, the pipe segments may be made up of a rigid material, preferably stainless steel. The fact that the pipe segments are made up of the rigid material has several benefits for the device according to the invention. In the machine cavity, such as a rotary machine, the temperature may be high, generally higher than about 150° C. Because the pipe is made up of a rigid material, the pipe may be heat-resistant. Furthermore, the pipe may be held in a fixed position. This fixed position prevents any shifting that could endanger the operation of the machine.

According to a specific manufacturing mode, the pipe of the system according to the invention may be laid in such a manner that the first end of the pipe may be embedded in a wall marking the enclosure inside which the machine is located. Thus, according to this specific method, the injection device may be located outside the enclosure. In this manner, the injection device may not be subjected to the high temperatures that may trigger uncontrolled activation. The Stat-X® 2500E aerosol cartridge, which is an example of an injection device, must be stored at a temperature between about −40° C. and 55° C. to avoid changes in the extinguishing agent and/or triggering of the cartridge. Thus, it is preferable that the injection device is not connected to the inside of the enclosure where the temperature is generally higher.

In a favorable manufacturing method, the injection device connected to the first end of the pipe may be fitted perpendicular to the wall. In other words, the injection device may be fitted horizontally and, due to this orientation, the injection in the pipe may be carried out horizontally.

In another manufacturing method, the pipe has a part that is adjacent to the first end of the pipe and aligned with the injection device. This preferred configuration avoids any collection of the extinguishant in the injection device.

The invention is also intended for a machine fitted with a device according to the invention. Favorably, the machine is a rotary machine.

Finally, another object of the invention is a fire extinguishing procedure in a machine fitted with a device according to the invention, including the injection of the extinguishant through the pipe. In a preferred manufacturing method, the discharge time of the extinguishant may be less than or equal to about 60 seconds. This maximum duration of the discharge time for the extinguishant is in fact preferred to comply with the NFPA standard (“National Fire Protection Association”) 2010 or ISO 15779 (“Condensed Aerosol Fire Extinguishing Systems”) and similar standards.

Favorably, the cartridge may be automatically triggered if the temperature sensor, placed in the cavity, detects a temperature higher than about 300° C. Thus, an electric signal may be sent to a controller or an automaton that remotely manages the activation of the cartridge trigger. According to another manufacturing method, the cartridge may be triggered manually with a button installed either close to the cartridge or in a control panel.

### BRIEF DESCRIPTION OF THE DRAWINGS

Other goals, characteristics, and benefits of this invention may clearly appear on reading of the following description, provided only as an illustrative and non-limiting example in reference to the drawings attached in which:

FIG. 1 is a diagram representing the system according to the invention in a special manufacturing method;

FIG. 2 is a diagram representing a special manufacturing method of the pipe of the system according to the invention;

FIG. 3 is a diagram representing a special method of the system according to the invention;

FIG. 4 is a diagram representing a first fire extinguishing test in a machine with the system according to the invention in a special execution method;

FIG. 5 is a diagram representing a second fire extinguishing test in a machine with the system according to the invention in a special execution method;

FIG. 6 is a graph representing the change in machine temperature during the first test as mentioned above according to the time; and

FIG. 7 is a graph representing the change in machine temperature during the second test as mentioned above according to the time.

### DETAILED DESCRIPTION

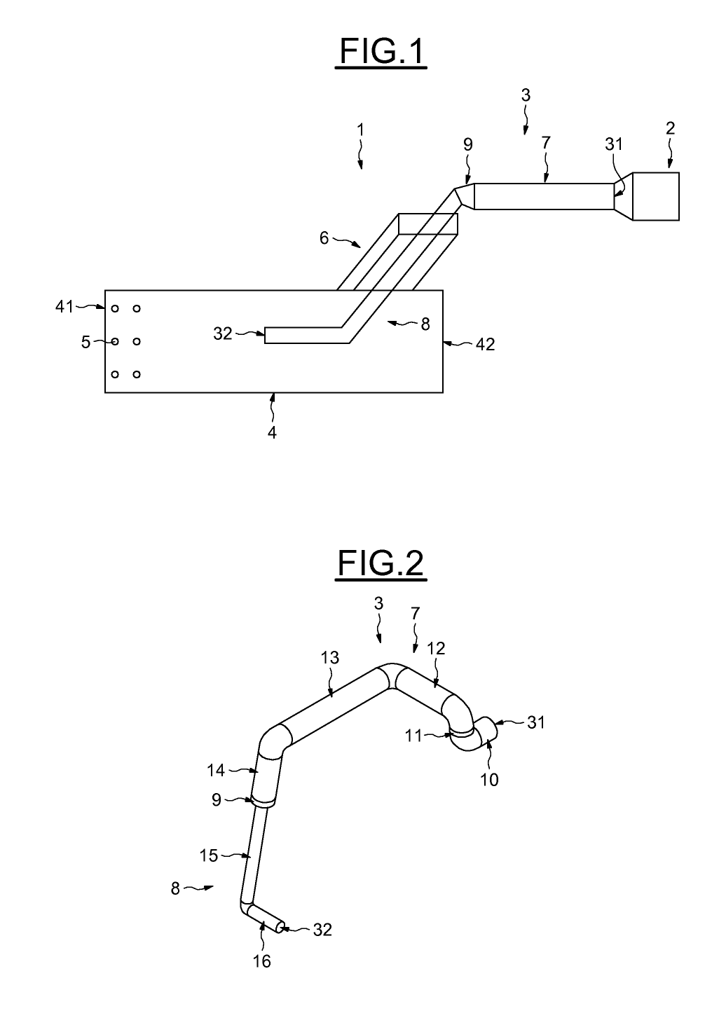

FIG. 1 illustrates a system 1 according to the invention in a special execution method, used during the fire extinguishing tests. As shown in FIG. 1, the system 1 may include an aerosol cartridge 2, which acts as the injection device 2, a pipe 3, and a cylinder 4 acting as a cavity 4 of a machine. (In the description of the invention, the terms “injection device” and “cartridge” and the terms “cylinder” and “cavity” are used interchangeably. The term “based on” is synonymous with the term “mainly comprising”.)

The pipe 3 may include a first end 31 connected to the aerosol cartridge 2 and a second end 32 inserted in the cylinder 4. The cylinder or the cavity 4 may have holes 5 pierced in the curving surface of the cylinder 4 in order to simulate the presence of a ventilation system inside a machine, and specifically in a rotary machine. In the example provided in FIG. 1, the holes 5 may be created in the form of two parallel series of holes 5 at a first end 41 of the cylinder 4.

Furthermore, the cylinder 4 may have a manhole or a ventilation duct 6 created close to a second end 42 of the cylinder 4 and connected to the curving surface of the cylinder 4. The pipe 3 may be dimensioned in a manner that it can be inserted in the cylinder 4 through the manhole or the ventilation duct 6.

The pipe 3 may have a first segment 7 with the first end 31 connected to the cartridge 2 and a second segment 8 with the second end 32 within the cylinder 4. The two segments 7 and 8 may be connected to each other. FIG. 2 illustrates a special execution method of the pipe 3 of system 1 according to the invention.

The pipe 3 may have the first segment 7 and the second segment 8 with the second segment being lower than the first segment 7. The two segments 7 and 8 may be connected to each other with a cone coupling 9. The first segment 7 may be divided into five parts. A first part 10, meant to be connected to the cartridge 2 at the first end 31, may define an outer angle with a second part 11. The second part 11 and a third part 12 may define a new outer angle. The plane defined by the parts 10 and 11 may be orthogonal to the plane defined by the parts 11 and 12. The third part 12 and a fourth part 13 may define an outer angle in a manner that the plane defined by the parts 12 and 13 may be orthogonal to the plane defined by the parts 11 and 12 and the plane defined by the parts 10 and 11. The fourth part 13 and a fifth part 14 may define an obtuse outer angle in a manner that the plane defined by the parts 13 and 14 may be parallel to the plane defined by the parts 10 and 11.

According to this special execution method, the length of the first part 10 may be about 300 mm. The length of the second part 11 may be about 680 mm. The length of the third part 12 may be about 1110 mm. The length of the fourth part 13 may be about 1660 mm. The length of the fifth part 14 may be about 450 mm. Other dimensions may be used herein.

The second segment 8 may be divided into two parts. A first part 15 may be connected to the fifth part 14 with a cone coupling 9 in a manner that the two parts 14 and 15 form an angle of approximately 180°. Finally, the first part 15 and a second part 16, meant to be inserted in the cylinder 4 from the second end 32, may define an obtuse outer angle in a manner that the plane defined by the parts 14 and 15 may be noticeably parallel to the plane defined by the parts 11 and 12.

According to this special execution method, the length of the first part 15 may be about 1427 mm. The length of the second part 16 may be changed according to the size of the cavity and the area wherein the extinguishant is to be injected.

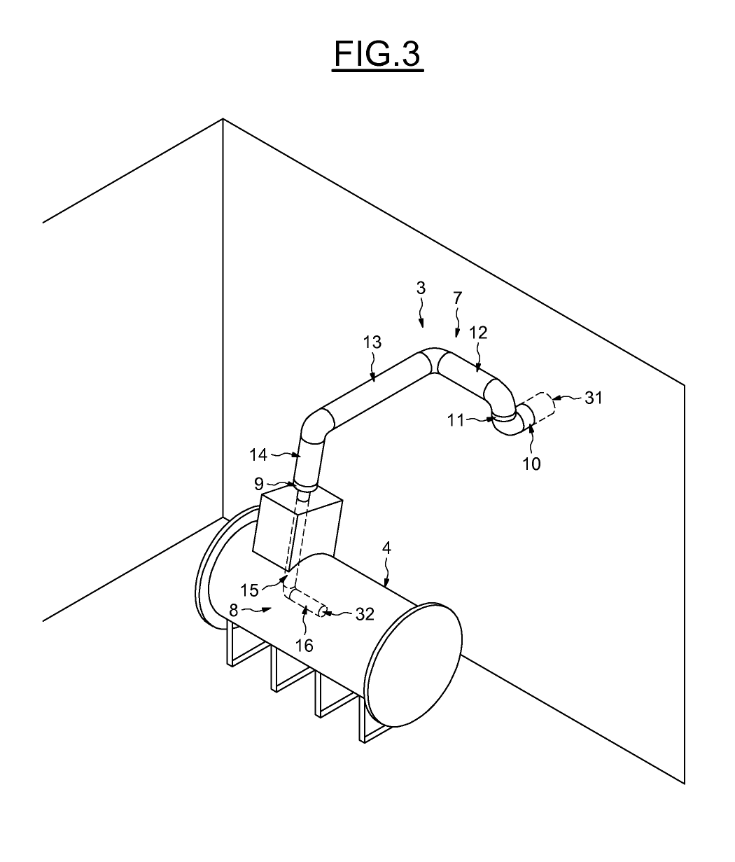

FIG. 3 illustrates a special execution mode of the system according to the invention located inside the enclosure wherein a machine is located. In fact, in this figure, one must imagine that the cavity or the tunnel housing the bearings is located along the axis of the machine. In fact, inside this cavity housing the bearings, a fire may be sparked off due to oil leakage combined with the presence of air at high temperature due to the friction of the bearings.

All the elements represented in this FIG. 3 are present in FIG. 1 and FIG. 2. Furthermore, FIG. 2 clearly reveals the fact that the two segments 7 and 8 may be connected to each other with a cone coupling 9 and that the first segment may be configured in a manner that the cone coupling 9 may be outside the manhole or ventilation duct 6 once the pipe 3 is inserted in the cylinder 4. It is also clear that the first part 10 of the first segment 7 may be perpendicular to the wall marking the enclosure of the machine. The first end may be embedded in the wall in a manner that the cartridge 2, connected to this first end, may be located outside the enclosure.

### Examples

In the examples given below, the aerosol cartridge may be a cartridge sold under the trade name Stat-X® 2500E. The cartridge may include an ultrafine potassium-based aerosol composition. After activation, the composition may pass through oxidation filters and coolants before being released. The temperature sensors, having about a 1.5 mm diameter, may be type K thermocouples.

1. Description of Fire Extinguishing Tests in a Machine Cavity.

Two fire extinguishing tests in the machine cavity 4, and specifically a rotary machine cavity, are conducted to represent all of the possible configurations of a fire that is sparked off.

1.1 First Fire Extinguishing Test.

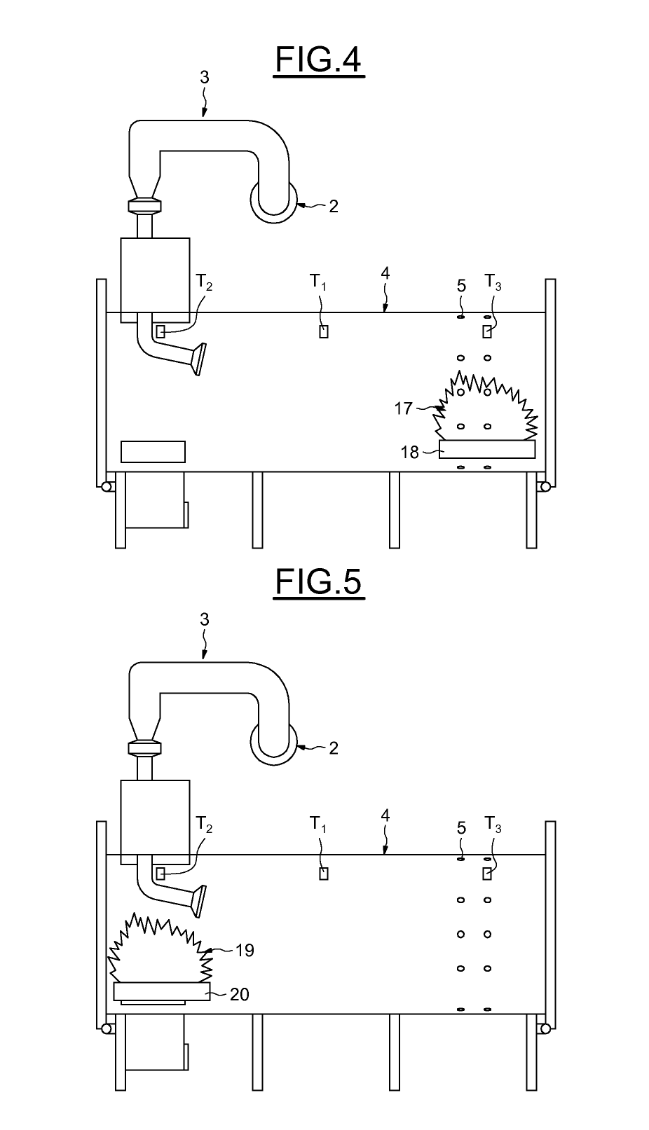

In the first test (FIG. 4), a fire 17 is lit in the right part of the cylinder 4 opposite to the end 32 of the second segment 8, i.e., near the holes 5, with about 7.5 liters of diesel fuel. The cylinder 4 may have about a 3500 mm height and about a 635 mm radius. Twenty holes 5 may be pierced therein. The diameter of each hole may be about 20 mm. The fire 17 may be in a combustor 18 having a diameter of about 80 cm and whose center is located about 60 cm from the cylinder end. The second end of the pipe 3, inserted in the curving surface of the cylinder 4 close to the left end of the cylinder 4, may be directed towards the fire. The cylinder 4 may be fitted with three temperature sensors. Sensor T1 may be located in the center of the cylinder 4 in the upper part. Sensor T2 may be located in the left part of the cylinder 4, where the pipe 3 is inserted in the cylinder 4. Finally, sensor T3 may be located in the right part of the cylinder 4, above the fire 17.

After ignition of the fire 17, about a 2 minute period may be allowed for the fire to stabilize 17 at a temperature of approximately 385° C. The force of the fire may be about 1 MW. During this stabilization period, the right door of the cylinder 4 may be opened only to facilitate the rise in fire temperature. At the end of this period, the cylinder 4 may be closed to simulate the ventilation conditions of a machine, specifically a rotary machine. Simultaneously, the cartridge 2 may be activated. The fire extinguishing time may be measured with the help of the temperature sensors.

Fifteen minutes after activation of the cartridge 2, a fire re-ignition test may be conducted. The behavior of the fire may be observed. The fire re-ignition tests may be repeated respectively at 30 minutes, 45 minutes, and 60 minutes following activation of the cartridge 2.

1.2 Second Fire Extinguishing Test.

In the second test (FIG. 5), a fire 19 may be ignited in the left part of the cylinder 4. This test allows for checking the performance of the system in case of the fuel spreading in the cavity and, specifically, spreading close to the end 32 of the second segment 8. The fire 19 may be in a combustor 20 having a diameter of about 80 cm and whose center may be located about 60 cm from the cylinder end. Thus, the second end of the pipe 3, inserted in the same manner as during the first test, may be located above the fire 19 and this time the pipe 3 may not be directed towards the fire 19. The cylinder 4 may be fitted with the three same temperature sensors, located at the same place as during the first test.

The fire ignition process may be fully identical to that which was followed during the first test. The re-ignition tests also may be identical.

2. Test Results.

In both the tests, the cartridge 2 was weighed before and after injection through the pipe 3. In both the cases, a weight loss of about 1.9 kg was noted. Thus, about 1.9 kg of the aerosol composition was released from cartridge 2. The pipe 3 also was weighed before and after injection. In both the cases, it was noted that approximately 25% of the aerosol composition remained in the pipe 3.

2.1 First Test Result.

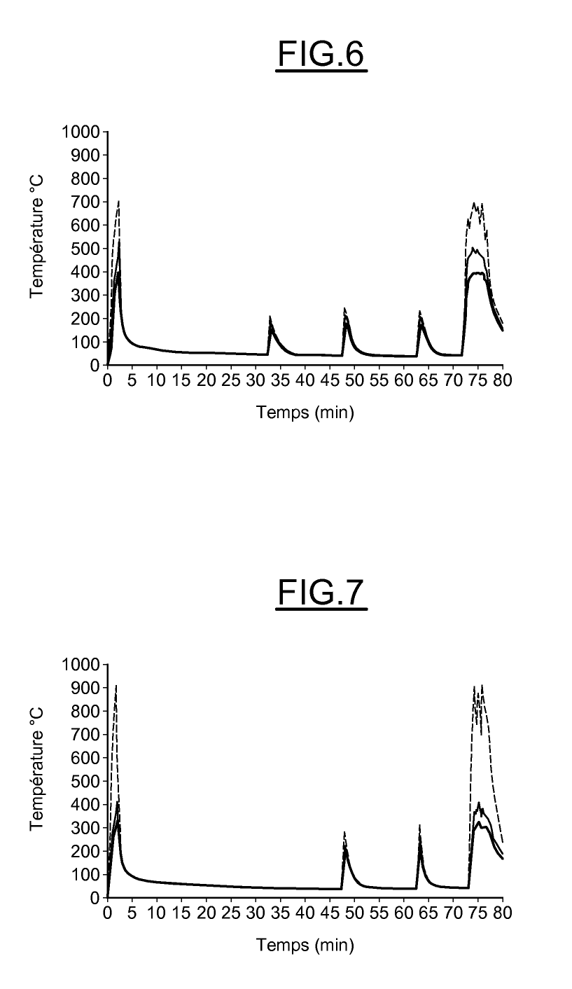

According to FIG. 6, the temperature at the time of the activation of the cartridge 2 was about 700° C. at the sensor T3. This proves that the fire 17 had been effectively ignited. The temperatures at sensors T1 and T2 are lower as the fire 17 was not directly under these sensors. An immediate and rapid fall in temperature for the three sensors was observed. Thus, less than about 20 seconds of fire extinguishing time was estimated. This leads to the conclusion that the aerosol composition contained in the cartridge 2 was effective in extinguishing the fire 17 and that the quantity of the aerosol composition injected was sufficient.

15 minutes following activation of the cartridge 2, a fire re-ignition test was conducted. No temperature rise was observed. This proves that the fire could not be re-ignited. It is thereof concluded that the aerosol composition was still present in the cavity 4 in a sufficient quantity to prevent re-ignition of the fire.

30 minutes following activation of the cartridge 2, a further fire re-ignition test was conducted. The sensor T3 measured an approximate temperature of about 200° C. Thus, the fire was effectively ignited. This established that the aerosol composition was no longer effective. In fact, the aerosol composition had the time to escape out of the cylinder 4 through the holes 5 and thus was no longer present or no longer present in a sufficient quantity. This said, the temperature dropped immediately thereafter. Thus, it was estimated that the fire went out in a little less than about 120 seconds. Because this time was longer than the 20 seconds noted at the start of the experiment, it was then proposed that the fire had gone out due to a lack of oxygen.

The same observations and conclusions prevailed for the further fire re-ignition tests at respectively 45 and 60 minutes after the activation of the cartridge 2. The last temperature rise was observed about 70 minutes following activation of the cartridge 2 in a fire re-ignition test, after the opening of the right door of the cylinder 4, to check that the system used for the ignition of the fire was still operational.

2.2 Second Test Result.

According to FIG. 7, the temperature at the time of the activation of the cartridge 2 may be about 900° C. at the sensor T2. This proves that the fire 19 had been effectively ignited. The temperatures in sensors T1 and T3 may be lower as the fire 19 is not directly under these sensors. As with the first test, an immediate and rapid drop in the temperature for the three sensors was observed. Thus, less than about 20 seconds of fire extinguishing time was estimated. This leads to the conclusion that the aerosol composition contained in the cartridge 2 was effective in extinguishing the fire 19 and that the quantity of the aerosol composition injected was sufficient.

15 minutes following activation of the cartridge 2, a fire re-ignition test was conducted. In the same manner as during the first test, no temperature rise was observed thus providing proof that the fire could not be re-ignited. It is thereof concluded that the aerosol composition was still present in the cavity 4 in a sufficient quantity to prevent re-ignition of the fire.

30 minutes following activation of the cartridge 2, a further test fire re-ignition test was conducted. This time, no actual temperature rise was observed, indicating that the fire could not be ignited. Contrary to the first test, the aerosol composition was still effective. Thus, the aerosol composition was present in a sufficient quantity to prevent resumption of the fire.

This behavior may be different from that during the first test due to the position of fire in the second test away from the holes 5 pierced in the right part of the cylinder. In the first test, the fire may be close to the holes 5 and thus may be ventilated more easily. Thus, the oxygen concentration may rapidly rise. This may be why the fire could be reignited within 30 minutes during the first test.

On the other hand, for tests conducted at 45 minutes and 60 minutes following the activation of the cartridge 2, the sensor T2 measured an approximate temperature of 280° C. immediately thereafter. Thus, the fire was effectively re-ignited. This proved that the aerosol composition was no longer effective. In fact, the aerosol composition had the time to escape out of the cylinder 4 through the holes 5 and thus was no longer present or no longer present in a sufficient quantity. This said, the temperature dropped immediately thereafter. Thus, it was estimated that the fire went out in a little less than about 120 seconds. Because the time was longer than the 20 seconds noted at the start of the experiment, it was then proposed that the fire had gone out due to a lack of oxygen.

The same system check test used for fire ignition also was conducted at the end of the experiment.

Thus, according to the invention, the system allows for the rapid extinguishing of a fire that ignites in the machine cavity, and particularly, in a rotary machine. It also prevents the possibility of the resumption of the fire within 15 minutes following the start of the fire, irrespective of the position of the fire in the cavity.

15 minutes following the start of the fire, renewal of air is very important to prevent resumption of fire due to the rise in the concentration of oxygen and the disappearance of the aerosol composition through the ventilation system. Nevertheless, the oxygen concentration in the cavity is not high enough as the re-ignition of a fire is immediately followed by fire suppression. In fact, the fire cannot spread.

I claim:

1. A system to extinguish fire in a machine cavity, comprising:
a pipe; and
an injection device for injecting an extinguishant in the pipe;
the pipe comprises a first end connected to the injection device and a second end configured to be inserted in the machine cavity.

2. The system of claim 1, wherein the system is configured to be inserted in a rotary machine cavity.

3. The system of claim 1, wherein the extinguishant comprises an aerosol.

4. The system of claim 1, wherein the extinguishant comprises a potassium-based product.

5. The system of claim 1, wherein the pipe comprises a first segment with a first segment end connected to the injection device and a second segment with a second segment end configured to be inserted in the machine cavity.

6. The system of claim 5, wherein the first segment and the second segment are connected to each other and the first segment is above the second segment.

7. The system of claim 5, wherein the first segment and the second segment are connected with a cone coupling.

8. The system of claim 7, wherein the second segment is configured such that the cone coupling is outside the manhole or the ventilation duct once the pipe is inserted in the machine cavity.

9. The system of claim 5, wherein the position and direction of the second segment in the machine cavity are adjustable.

10. The system of claim 5, wherein the first segment and the second segment comprise a stainless steel material.

11. The system of claim 5, wherein the first segment comprises five parts and the second segment comprises two parts.

12. The system of claim 1, wherein the injection device comprises an aerosol cartridge.

13. The system of claim 1, wherein the pipe is configured to be inserted in the machine cavity through a manhole or a ventilation duct.

14. The system of claim 1, wherein the quantity of the extinguishant injected in case of fire is between about 1 and 3 kg.

15. The system of claim 1, wherein a discharge time of the extinguishant is less than or equal to about 60 seconds.
